(19) United States
(12) Patent Application Publication
(10) Pub. No.: US 2026/0364535 A1
(43) Pub. Date: Nov. 19, 2026

(54) FILTRATION UNIT WITH A FILTRATION ELEMENT AND A SCREENING DEVICE

(71) Applicants: DDP SPECIALTY ELECTRONIC MATERIALS US, LLC, Wilmington, DE (US); DUPONT SAFETY & CONSTRUCTION, INC., Wilmington, DE (US)

(72) Inventors: Bie LI, Huzhou (CN); Michael HOFFMANN, Greifenberg (DE); Christian STAAKS, Greifenberg (DE); Martin HEIJNEN, Greifenberg (DE); Michael KASSEN, Greifenberg (DE); Dominik BOTSCHAFTER, Greifenberg (DE)

(21) Appl. No.: 19/144,169

(22) PCT Filed: Dec. 29, 2023
(86) PCT No.: PCT/CN2023/143102

§ 371 Date: Jun. 27, 2025

Related U.S. Application Data
(60) Provisional application No. 63/477,616, filed on Dec. 29, 2022.

(51) Int. Cl. B01D 61/14; B01D 35/02; B01D 61/18; B01D 63/04

(52) U.S. Cl. CPC B01D 61/145; B01D 35/02; B01D 61/147; B01D 61/18; B01D 63/046; B01D 2313/20; B01D 2317/06; B01D 2321/04

(57) ABSTRACT

Provided herein is a filtration unit comprising a filtration element and a screening device. The screening device comprises screening mesh body an orifice substantially positioned in the center of the screening device, a external ring in the outer periphery of the screening device, and a screening mesh body therebetween. Further provided is a filtration system comprising a vessel, a feed port, a permeate outlet, optionally a retentate outlet, and at least a filtration unit within the vessel, and for at least one set of the filtration units, the screening device is positioned upfront of the filtration element in feed flow direction.

### FIELD OF THE INVENTION

Provided herein are filtration elements and filtration systems with integrated pre-filters. More specifically, a filtration unit comprises a filtration element and a screening device. The screening device comprises a screening mesh body and an orifice substantially positioned in the center of the screening device, an external ring in the outer periphery of the screening device, and a screening mesh body therebetween. The external ring comprises an inner surface connected to the housing.

### BACKGROUND OF THE INVENTION

Several patents, patent applications and publications are cited in this description in order to more fully describe the state of the art to which this invention pertains. The entire disclosure of each of these patents, patent applications and publications are incorporated by reference herein.

Filtration media, for example, membranes such as reverse osmosis (RO), nanofiltration (NF), ultrafiltration (UF), microfiltration (MF), electrodialysis (ED), distillation, degassing and ion exchange membrane, is commonly and effectively used for fluid treatment. By applying a driving force, in most cases pressure, to one surface of the membrane, the membrane is able to separate a feed fluid into a permeate stream that passes through the membrane and a retentate stream that contains the filtered materials. The most important application is the purification of water, by treating process streams such as industrial waste, seawater, ground water, sewage and effluent from sewage treatment facilities. Other industrial uses include purifying and/or concentrating dairy products, fruit juices and other beverages; enzyme recovery; and dialysis.

MF membranes commonly have a pore size between 0.1 micron to several microns, which can be used to remove large microbial matter such as some bacteria. UF membranes typically have a pore size between 0.1 micron to 0.01 micron, which is small enough to separate a wider range of microbes, including viruses and other pathogens, as well as macromolecules, nanoparticles, proteins, biological cell debris and so forth. NF membranes usually have a pore size between 0.001 micron to 0.01 micron, effectively to remove divalent ions, most organic molecules, nearly all viruses, and a range of salts. RO membranes generally have a pore size between 0.0001 micron to 0.001 micron, which is by far the finest membrane available in industry to remove all organic molecules, viruses and most minerals.

The membranes are susceptible to fouling and damage from larger particles. Therefore, before feeding to the filtration system, coarse screening and/or fine screening is used to treat the feed fluid to remove large particles which may damage or block the membranes in the filtration system. In general, for UF and MF systems, the pre-treatment includes self-cleaning filters with the screening size from 50 microns to 400 microns, more preferably from 100 microns to 300 microns. Often, UF and/or MF membranes are used as a pre-treatment for the finer membranes RO and NF.

Since the pre-filter used in pre-treatment is used to remove larger particles, it is easily blocked and requires frequent cleaning, for example backwash and/or chemical cleaning, to recover the original flux. UF and MF membranes are used to remove relatively large particles; regular cleaning of these membranes is also required. Normal cleaning processes for UF and MF membranes include, without limitation, backwash, air scouring, chemical enhanced backwash (CEB), and clean in place (CIP). Among the cleaning processes for UF and MF membranes, the most frequently applied one is backwash which is normally cycled once every 20 to 60 minutes based on feed conditions. For RO and NF membranes, which are generally composite membranes, CIP is an effective cleaning process. In industrial and wastewater treatment settings, pre-treatment is performed using a separate prefilter system upstream of the filtration system, that is, the pre-treatment filter is generally separated from the downstream filtration system as a separated device. In these cases, there are usually separate and time-consuming cleaning processes for the pre-treatment filter and the filtration system.

To reduce footprint of a system, the amount of piping and the number of connections, a plurality of filtration elements may be employed within a pressure vessel to form a multi-element filtration system. In these designs, the multi-element filtration system has a single set of a feed port, a permeate outlet and a retentate outlet, instead of having one set for each element. Multi-element filtration systems are used widely in water treatment facilities to purify water, and also as reactors in various chemical manufacturing processes. The most commonly used commercial RO system is a multi-element filtration system comprising multiple RO elements placing horizontally in series in a pressure vessel (FIG. 1a). There is also a horizontal system with RO elements placed in parallel (FIG. 1b). Commercial multi-element UF or MF systems include horizontal elements in series (FIG. 1a) and vertical elements in parallel (FIG. 1c). Vertical elements may be placed in a series as well (FIG. 1d). Generally horizontal multi-element UF or MF systems use inside-out membranes and vertical multi-element UF or MF systems use outside-in membranes.

There have been attempts to integrate pre-filters with the filtration element or system. Examples can be seen in JP03193122, JP04338221 and CN218249518 for integrating a pre-filter to an element housing and CN216358934 for inserting a pre-filter to the element from the side of the housing. Examples can also be seen in KR10-1303993 for integrating a screening within a vertical multi-element system, and in WO2016042179 for integrating a cylindrical pre-filter underneath above vertically arranged filtration elements.

Nevertheless, there remains a need to integrate a pre-filter with an element that is easily handled, transported, and installed into a multi-element system. Especially for a UF or MF element treating the raw liquid with relative high turbidity, there is a need to integrate a pre-filter with the element to enable easy handling, transportation and installation into a multi-element system. In addition, there is a need to integrate the pre-filter with the filtration element or system in a simple and effective way is essential for the installation and cost control.

### SUMMARY OF THE INVENTION

Accordingly, provided herein is a filtration unit comprising:
a filtration element with at least one filtration membrane with a first surface which is to contact feed and a second surface which is to contact permeate, at least one end of the filtration element comprising openings to introduce feed to the first surface of the filtration membrane, and a central pipe surrounded by the filtration membrane to collect permeate; and
a screening device that is preferably connected to the end of the filtration element comprising one or more openings to introduce feed to the first surface of the filtration membrane, the screening device comprising an orifice substantially positioned in the center of the screening device, an external ring in the outer periphery of the screening device, and a screening mesh body therebetween.

The filtration membrane may be surrounded by a housing. The external ring may comprise an inner surface connected to the housing. The external ring may further comprise an external surface with at least a supporting rib.

The inner surface of the external ring is preferably connected with the housing by optional snap-in means, corresponding grooves and protrusions, screw threads, heat welding, press welding, glue, or other non-limited ways. Preferably the inner surface of the external ring is sealed relatively to the housing of the filtration element to avoid the feed flowing to the first surface of the filtration membrane between the potential gap between the inner surface of the external ring and the housing.

The external ring may further comprise an external surface with at least a supporting rib. Preferably there are multiple supporting ribs. The multiple supporting ribs may be separated into groups and preferably the groups of the supporting ribs are placed in a uniform spacing. When the filtration unit is placed into a common vessel, the supporting rib of the external ring may be used to face against the inner surface of the vessel, preventing the filtration unit from deviation from the required position. Optionally, the supporting rib may be a circular O-ring around the external ring to seal between the external ring and the inner surface of the vessel.

The filtration unit may further comprise two ends, and each of the two ends may comprise openings via which the feed can be introduced to the first surface of the filtration membrane. The filtration unit may further comprise two or more screening devices, and the screening devices may be placed at both sides of the filtration element. In addition, the feed flow direction of the filtration unit may be reversable. That is, the feed can be introduced from either or both sides of the filtration element.

The filtration element may be connected directly with the screening device by attaching and fixing the screening device to the filtration element, for example, the external ring of the filtration element may comprise an inner surface connected to the housing.

The filtration unit may further comprise a connector to direct the permeate collected in the central pipe of the filtration element and may further be equipped with a sealing means. The connector may connect with both the screening device and the filtration element by insertion through the orifice of the screen device and into the central pipe of the filtration element. The sealing means seals between the connector and the central pipe, forming a fluid seal between the feed and the permeate. The connector may further comprise another sealing means to seal between the connector and the orifice.

The filtration element may be connected indirectly with the screening device by fitting the connector to connect both the screening device and the filtration element separately.

The filtration membrane is selected from the group consisting of microfiltration, ultrafiltration, nanofiltration, distillation, degassing, ion exchange and reverse osmosis membranes, preferably microfiltration and ultrafiltration membranes.

The screening device may further comprise at least two layers of screening mesh bodies between the orifice and the external ring. Preferably, at least two layers of the screening mesh bodies have different screening sizes. When the filtration membrane is UF or MF membrane, the screening mesh body preferably has a screening size of between 50 microns and 400 microns, more preferably between 100 microns and 300 microns, still more preferably between 100 microns and 150 microns.

Further provided is a filtration system comprising a vessel, a feed port, a permeate outlet, optionally a retentate outlet, and at least two filtration units described herein positioned in series within the vessel, each of the filtration units comprising
A filtration element with at least one filtration membrane with a first surface which is to contact feed and a second surface which is to contact permeate, at least one end of the filtration element comprising openings to introduce feed to the first surface of the filtration membrane, and a central pipe surrounded by the filtration membrane to collect permeate, and
A screening device connected to the end of the filtration element comprising one or more openings to introduce feed to the first surface of the filtration membrane; the screen device comprising an orifice substantially positioned in the center of the screening device, an external ring in the outer periphery of the screening device, and a screening body positioned between the orifice and the external ring.

The filtration membrane may be surrounded by a housing. The external ring may comprise an inner surface connected to the housing. The external ring may further comprise an external surface with at least a supporting rib.

In some embodiments, at least two filtration units are placed in series within the vessel. The first filtration unit and the second filtration unit are positioned in this order in feed flow direction, and for the first filtration unit, the screening device is positioned upfront of the filtration element in feed flow direction, and for the second filtration unit, the screening device is positioned downstream of the filtration element in the feed flow direction. The feed flow direction of the filtration system may be reversable. Alternatively, the feed may be introduced from either or both ends of the filtration system. There may be one or more individual membrane elements positioned in series without integrated screening devices between the two filtration units.

The filtration element of the filtration unit within the vessel may further comprise two ends, and both of the two ends may comprise openings via which the feed can be introduced to the first surface of the filtration membrane, and each end of the filtration element may be connected with at least one screening device. The filtration system may further comprise another feed port at the opposite end of the filtration system, and the feed may flow to either or both feed ports of the filtration system. The feed flow direction of the filtration system may be reversable. Alternatively, the feed can be introduced from either or both sides of the filtration system.

The filtration element is preferably connected directly with the screening device by attaching and fixing the screening device to the filtration element, for example, the external ring of the filtration element may comprise an inner surface connected to the housing.

The filtration unit may further comprise a connector to direct the permeate collected in the central pipe of the filtration element and equipped with a sealing means; and the connector connects with both the screening device and the filtration element by inserting it through the orifice of the screen device and into the central pipe of the filtration element. The sealing means seals between the connector and the central pipe, forming a fluid seal between the feed and the permeate. The connector may further comprise another sealing means to seal between the connector and the orifice.

The filtration element may be connected indirectly with the screening device by fitting the connector to connect both the screening device and the filtration element separately.

The external ring may further comprise an external surface The inner surface of the external ring is preferably connected with the housing by optionally snap-in means, corresponding grooves and protrusions, screw thread, heat welding, press welding, glue, and other non-limited ways. Preferably the inner surface of the external ring is sealed relatively to the housing of the filtration element to avoid the feed flowing to the first surface of the filtration membrane between the potential gap between the inner surface of the external ring and the housing.

The external ring may further comprise an external surface with at least a supporting rib. Preferably there are multiple supporting ribs. The multiple supporting ribs may be separated into groups and preferably the groups of the supporting ribs are placed in a uniform spacing. When the filtration unit is placed into a common vessel, the supporting rib of the external ring may be used to face against the inner surface of the vessel, preventing the filtration unit from deviation from the required position. Optionally, the supporting rib may be a circular O-ring around the external ring to seal between the external ring and the inner surface of the vessel.

The external ring may further comprise an inner surface connected to the housing by optionally snap-in means, corresponding grooves and protrusions, screw thread, heat welding, press welding, glue, and other non-limited ways. Preferably the inner surface of the external ring is sealed relatively to the housing of the filtration element to avoid the feed flowing to the first surface of the filtration membrane between the potential gap between the inner surface of the external ring and the housing.

When the filtration element is optionally connected indirectly with the screening device by fitting a connector to connect both the screening device and the filtration element separately, the inner surface of the external ring is not necessarily connected to the housing.

The connector may be used to direct the permeate collected in the central pipe of the filtration element and may also be equipped with a sealing means. There could be a first connector connecting with only one filtration element. There could also be a second connector connecting with two filtration elements, i.e., one filtration element on each side of the connector. The first connector and the second connector preferably comprise sealing means to seal between the connector and the central pipe of the filtration element, forming a fluid seal between the feed and the permeate. The first connector may further comprise another sealing means to seal between the connector and the orifice. The second connector may further comprise another sealing means to seal between the connector and the orifice.

The filtration membrane is selected from the group of microfiltration, ultrafiltration, nanofiltration, distillation, degassing, ion exchange and reverse osmosis membranes, preferably microfiltration and ultrafiltration membranes. The type of membrane is selected independently for each membrane element in the filtration units.

The screening device may further comprise at least two layers of screening mesh bodies between the orifice and the external ring. And at least two layers of the screening mesh bodies have different screening sizes. When the filtration membrane is UF or MF membrane, the screening mesh body preferably has a screening size of between 50 microns and 400 microns, more preferably between 100 microns and 300 microns, still more preferably between 100 microns and 150 microns.

The advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described one or more preferred embodiments of the invention.

### BRIEF DESCRIPTION OF THE DRAWINGS

FIG. 1 illustrates different types of multi-element filtration system of the prior art.

FIG. 2 illustrates a filtration unit as described herein.

FIG. 3 illustrates the front view of a screening device as described herein.

FIG. 4 illustrates a connector and a second connector as described herein.

FIG. 5 illustrates filtration systems with at least one filtration unit.

FIG. 6 illustrates a cross-section of part of a filtration system as described herein with at least two filtration units.

FIG. 7(a, b, and c) illustrate filtration systems of the prior art in original feed flow, reversed feed flow directions and feed from both sides of a filtration system.

FIG. 8 illustrates an embodiment of the filtration system as described herein.

FIG. 9 illustrates an embodiment of the filtration system as described herein.

### DETAILED DESCRIPTION OF THE INVENTION

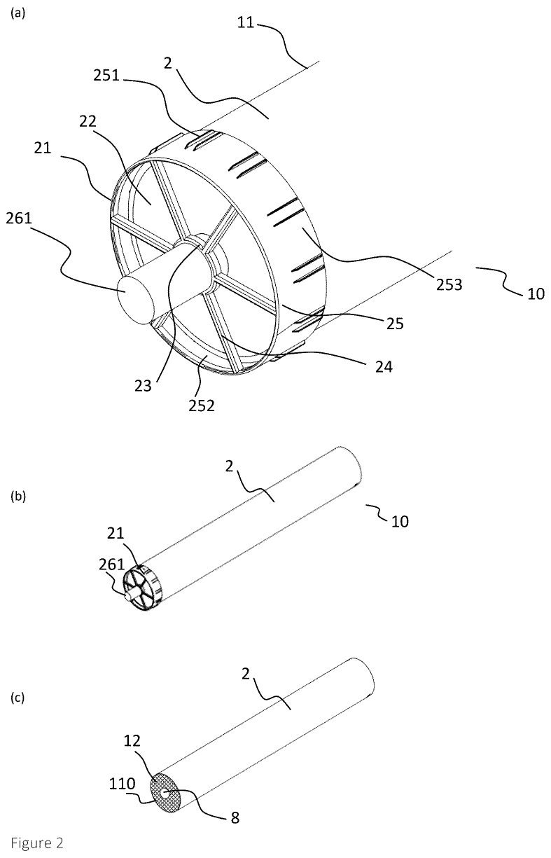

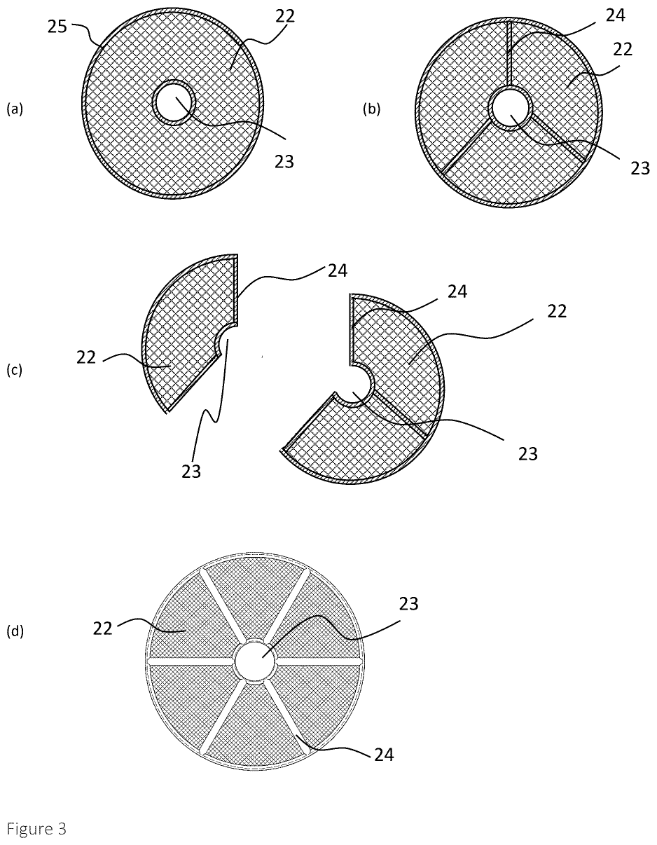

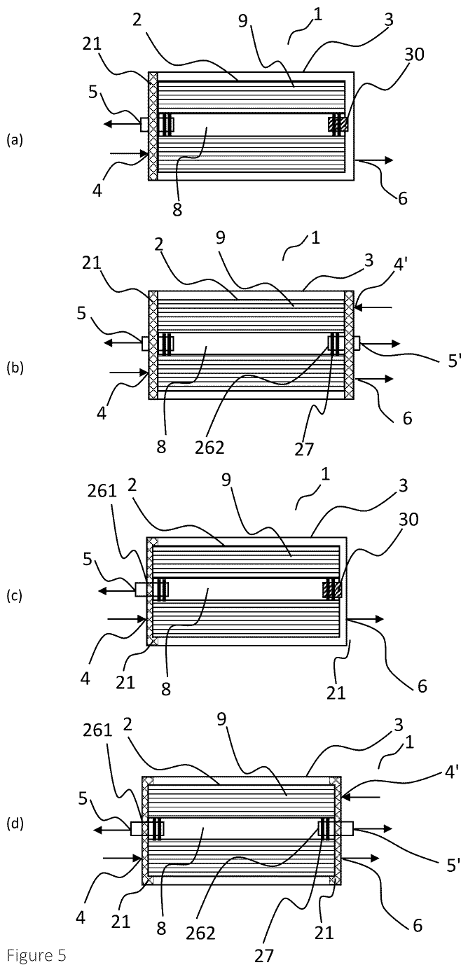

Referring now to the drawings, wherein like reference numerals designate corresponding structure throughout the views, and referring in particular to FIGS. 2 and 3, a filtration unit 10 comprises
A filtration element 2 with at least one filtration membrane 9 (see FIG. 5) with a first surface which is to contact feed and a second surface which is to contact permeate, at least one end 110 of the filtration element comprising openings 12 to introduce feed to the first surface of the filtration membrane, and a central pipe 8 surrounded by the filtration membrane 9 to collect permeate,
A screening device 21 comprising an orifice 23 substantially positioned in the central part of the screening device 21, an external ring 25 in the outer periphery of the screening device 21, and a screening mesh body 22 therebetween.

The external ring 25 comprises an inner surface 252 and an external surface 253. The external surface preferably comprises at least a supporting rib 251. The supporting rib 251 may be extended along the feed direction or around at least a part of the outer periphery of the external ring 25. Preferably there are multiple supporting ribs 251 which are separated into groups and preferably the groups of the supporting ribs 251 are placed in a relatively uniform spacing. When the filtration unit is placed into a common vessel 3, the supporting rib 251 of the external ring 25 may be used to face against the inner surface of the vessel 3 (see FIG. 5), preventing the filtration unit 10 from deviation from the required or pre-set position. Alternatively, the supporting rib 251 may comprise a circular O-ring around the outer periphery of the external ring 25 to seal between the external ring 25 and the inner surface of the vessel 3.

The filtration membrane 9 may be surrounded by a housing 11. The housing 11 may be a polymeric or metal tube, a cylindrical polymeric or metal netting, a spiral-wounded non-woven fabric, a winding band, two or more of these types of housing, or any other suitable means to surround the filtration membrane 9. The housing 11 may be permanent or temporary. For example, the housing 11 may be dissolved in water and washed away after the filtration element 2 is put into operation.

Alternatively, the filtration element 2 may not be equipped with a housing 11. An external ring 25 is disposed on one end of the filtration element 2. When the filtration elements 2 are installed in a common vessel 3, in one embodiment, the supporting ribs 251 on the external surface 253 of the external ring 25 helps to seal between the external ring 25 and the inner surface of the vessel; in another embodiment, the supporting ribs 251 helps to create a space between the filtration element 2 and inner surface of the vessel 3 for bypass flow.

The inner surface 252 of the external ring 25 may be connected to the housing 11 by optional snap-in means, corresponding grooves and protrusions, screw threads, heat welding, press welding, glue, a combination of two or more of these methods, or other non-limited ways. Preferably the inner surface 252 of the external ring 25 is sealed relatively to the housing 11 of the filtration element 2 to avoid the feed flowing to the first surface of the filtration membrane 9 between the potential gap between the inner surface 252 of the external ring 25 and the housing 11.

The screening device 21 comprises an orifice 23 substantially positioned in the center of the screening device 21, an external ring 25 in the outer periphery of the screening device 21, and a screening mesh body 22 therebetween. The feed flows through the screening mesh body 22, into the openings 12 in one end of the filtration element 2 and then to the first surface of the filtration membrane 9. Part of the feed passes through the filtration membrane 9 as a permeate to the second surface of the filtration membrane 9. The rest of the feed is a retentate stream that contains the filtered materials. The screening mesh body 22 may be a coarse screening (low mesh number) to remove large particles which may damage or block the filtration membranes 9 in the filtration element 2. Alternatively, the screening mesh body 22 may be a fine screening (high mesh number) to remove both larger and smaller particles from the raw feed. Ideally there is a sealing (not shown) around the orifice 23 to avoid the feed flowing into the filtration element 2 through the space around the orifice 23. The orifice 23 is preferably in the center of the screening device 21. As shown in FIG. 2 and FIG. 3a, the periphery of the screening mesh body 22 comprises an external ring 25 to hold the screening mesh body 22. The screening device 21 can be one piece (FIG. 3a, 3b) or combined by several pieces together (FIG. 3c).

As shown in FIG. 2a, FIG. 3b and FIG. 3d, the screening device 21 may further comprise supporting beams 24 in the area of the screening mesh body 22 as a reinforcement to strengthen the screening device 21 or as shown in FIG. 3c, as a combination part for several pieces to form a screening device 21. Different parts of the screening device 21 may be formed into one piece by glue or by other connecting means. The screening device 21 may be formed as one piece by injecting, molding or even 3D printing as one piece. Alternative, the polymeric parts of the screening device 21 may be formed as one piece and combined with the other parts made of non-polymeric materials.

The screening device 21 is made from organic or inorganic materials or a combination of the two. The organic screening device 21 can be made of any suitable polymer such as, for example, polyolefins (including fluorinated polyolefins), polyamides, polyacrylates, polyesters, copolyesters such as Tritan™ (available from the Eastman Chemical Co. of Kingsport, TN), polysulfones (PS), polyethersulfones (PES), sulfonated polyethersulfone (SPS), celluloses, polycarbonates (PC), polytetrafluoroethylene (PTFE), polychlorotrifluoro-ethylene (PCTFE), fluorinated ethylene polymer (FEP), polyvinylidene fluoride (PVDF), polyvinyl chloride (PVC), polyacrylonitrile (PAN), acrylonitrile butadiene styrene (ABS) and the combination of two or more of these polymers. The inorganic screening device 21 can be made of metals such as stainless steel, or ceramic components such as aluminum oxide, zirconium oxide, silicon oxide and the like, or the combination of two or more of these materials.

The filtration membrane 9 is selected from the non-limited group of microfiltration, ultrafiltration, nanofiltration, distillation, degassing, ion exchange and reverse osmosis membranes. The filtration membrane 9 is made from organic or inorganic materials or the combination of the two. The organic filtration membrane 9 can be made of any suitable polymer such as, for example, polyolefins (including fluorinated polyolefins), polyamides, polyacrylates, polyesters, copolyesters including Tritan™, polysulfones (PS), polyethersulfones (PES), sulfonated polyethersulfone (SPS), celluloses, polycarbonates, polytetrafluoroethylene (PTFE), polychlorotrifluoro-ethylene (PCTFE), fluorinated ethylene polymer (FEP), polyvinylidene fluoride (PVDF), polyvinyl chloride (PVC), polyacrylonitrile (PAN) and the combination of two or more of these polymers. The inorganic filtration membrane 9 can be a ceramic membrane made of any suitable material such as aluminum oxide, zirconium oxide, silicon oxide and the like and combinations of two or more of these materials. The ceramic membrane may be synthesized by a sintering method, a sol-gel method, a phase separation method, a vapor deposition method, or another suitable method known in the art. The filtration membrane 9 may be of any shape such as hollow fibers, tubes, multi-bore fibers, knitted fibers, spiral sheets, pleated sheets and flat sheets. In elements with more than one membrane 9, the membranes may have one or more of these shapes or be made of more than one of these materials.

Referring now to FIG. 2c, one or both ends 110 of the filtration element 2 comprise openings 12 to introduce feed to the first surface of the filtration membrane 9. Referring to FIGS. 5b and 5c, a filtration unit 10 may comprise two or more screening devices 21, 21′, and each end of the filtration element 2 is connected with at least one screening device 21, 21′. The two or more screening devices 21, 21′ can be placed together in parallel aligned by the orifices 23. The two or more screening devices 21, 21′ can be placed at both sides of the filtration element 2. The two or more screening devices 21, 21′ may be the same, or they may have different screening sizes, material types, or shapes. The feed flow direction of the filtration unit 10 is reversable. Alternatively, the feed can be introduced from either or both sides of the filtration unit 10. As shown in FIGS. 5b and 5d, each end of the filtration element 2 may be connected with one screening device 21, 21′.

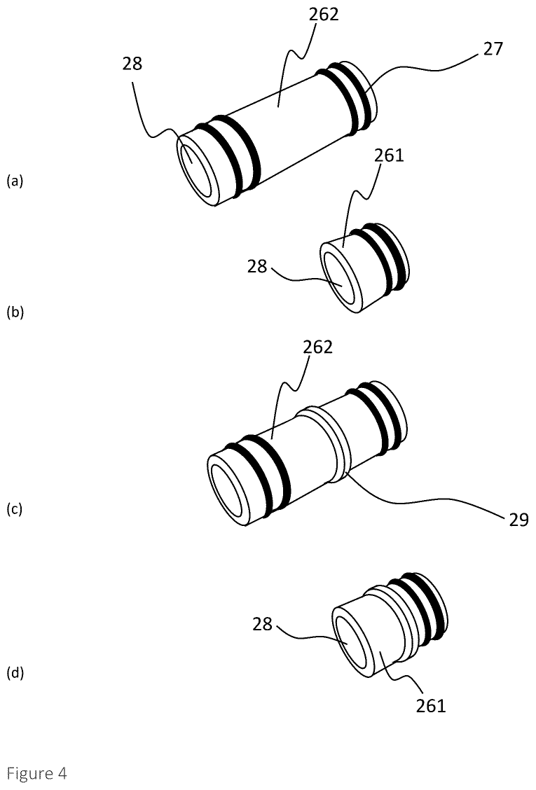

The filtration element 2 is connected directly with the screening device 21 by attaching and fixing the screening device 21 to the filtration element 2, in one embodiment, by fixing the external ring 25 to the housing 11, as depicted in FIG. 2. And in this embodiment, a connector 261,262 as shown in FIG. 4 may be used to direct the permeate collected in the central pipe 8 of the filtration element 2. Alternatively, the filtration unit 10 may use the connector 261,262 to connect both the filtration element 2 and the screening device 21 so the filtration element 2 is connected indirectly with the screening device 21 whose external ring 25 has no direct connection to the housing 11 of the filtration element 2, by fitting the connector 261,262 to connect both the screening device 21 and the filtration element 2 separately.

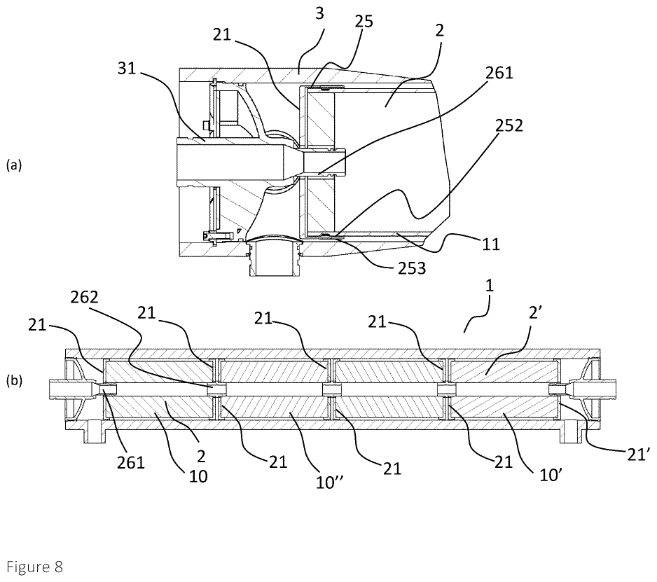

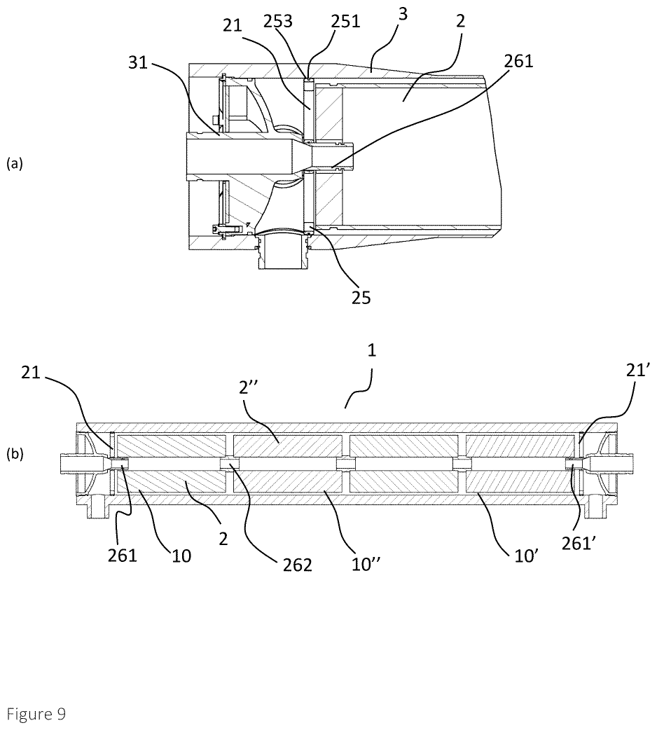

As shown in FIG. 4, the connector 261,262 may be a hollow tube with a hollow chamber 28. The connector 261,262 directs the permeate collected in the central pipe 8 of the filtration element 2 and is equipped with a sealing means 27. The connector 261,262 connects with both the screening device 21 and the filtration element 2 by inserting through the orifice 23 of the screen device 21 and inserting into the central pipe 8 of the filtration element 2 and the sealing means 27 seals between the connector 261,262 and the central pipe 8, forming a fluid seal between the feed and the permeate. The first connector 261 has sealing means 27 at one end (FIG. 4b, 4d) to connect to and seal with only one filtration membrane 2. The second connector 262 has sealing means 27 at both ends (FIG. 4a, 4c) and each end of the connector 262 connects to and seals with one filtration membrane 2. The connector 261,262 may further comprise a protruded base 29 for a screening device 21 to align with and/or rest on. Such protruded base 29 also enables a constant spacing between neighboring filtration elements 2 on both sides of the protruded base 29. The first connector 261 may further comprise additional part or connected to addition part of the filtration system 1, such as a cover 31 shown in FIG. 8a and FIG. 9a.

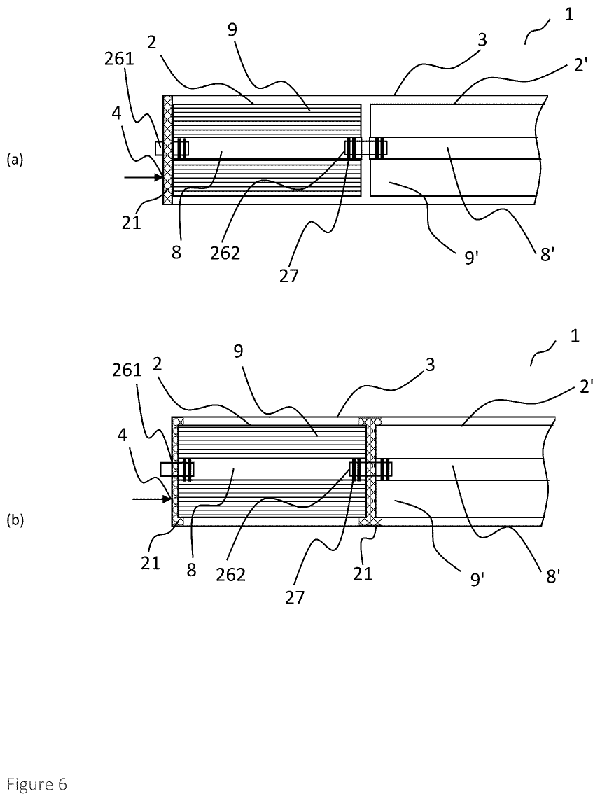

Referring now to FIG. 5 and FIG. 6, the first connector 261 is connected to the filtration element 2 by inserting the end with sealing means 27 into the central pipe 8 of the filtration element 2. Sealing means 27 forms a fluid seal, that is, a seal that is not permeable by gas or liquid, between the feed and the permeate. The first connector 261 is connected to the screening device 21 by inserting one end of the first connector 261 through the orifice 23 of the screening device 21.

Optionally, without a first connector 261, the filtration element 2 comprises a protrusion (not shown), fitting to connect with the screening device 21 by inserting the protrusion through the orifice 23 of the screening device 21.

Referring now to FIGS. 5(a-d), further provided herein is a filtration system 1 comprising a vessel 3, two sides with multiple ports including a feed port 4, a permeate outlet 5, and optionally a retentate outlet 6, and at least one filtration unit 10 as described herein (shown in FIG. 2) within the vessel 3, said system comprising
A filtration element 2 with at least one filtration membrane 9 with a first surface which is to contact feed and a second surface which is to contact permeate, at least one end 110 of the filtration element 2 comprising openings 12 to introduce feed to the first surface of the filtration membrane, and a central pipe 8 surrounded by the filtration membrane 9 to collect permeate, and
A screening device 21 connected to the end 110 of the filtration element 2 comprising one or more openings 12 to introduce feed to the first surface of the filtration membrane 9;

Wherein the screening device 21 comprises an orifice 23 substantially positioned in the central part of the screening device 21, an external ring 25 in the outer periphery of the screening device 21, and a screening mesh body 22 therebetween.

The screening device 21 may further comprise at least two layers of screening mesh bodies 22 between the orifice 23 and the external ring 25. And at least two layers of the screening mesh bodies 22 have screening sizes that may be the same or different. When the filtration membrane is UF or MF membrane, the screening mesh body 22 preferably has a screening size of between 50 microns and 400 microns, more preferably between 100 microns and 300 microns, still more preferably between 100 microns and 150 microns.

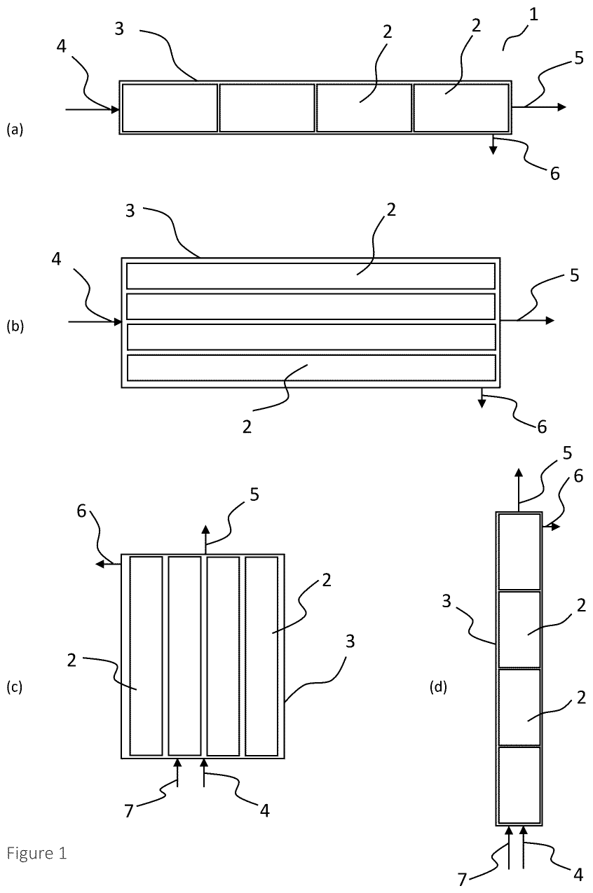

To reduce footprint, as shown in FIG. 1, at least two sets of the filtration units 10 are placed within the vessel 3. The filtration units 10 may be positioned in series in horizontal direction or in vertical direction. There is preferably an air inlet port 7 for the vertical system, as shown in FIG. 1c and FIG. 1d. Preferably the filtration units 10 are positioned in series in horizontal direction.

As shown in FIG. 6, FIG. 8b and FIG. 9b, at least two sets of the filtration units 10 may be placed in series in horizontal direction within the vessel 3. Preferably, next to each side of the filtration system 1 positioned one screening device 21 of one filtration unit 10. For example, in FIG. 8b and FIG. 9b, a screening device 21 is positioned next to one side of the filtration system 1 and another screening device 21′ is positioned next to the other side of the filtration system 1. The feed flow direction of the filtration system 1 is reversable. The feed can be introduced from the feed port 4 for some period of operation, and then the feed can be reversed and introduced from the feed port 4′ for another period of operation. Alternatively, the feed can be introduced from either or both sides of the filtration system 1. The feed can be introduced from either or both of the feed port 4, 4′.

Referring now to FIG. 6b, the second connector 262 is connected to two filtration elements 2, 2″. Each end of the second connector 262 is connected to one filtration element 2 by inserting the end with sealing means 27 into the central pipe 8 of the filtration elements 2, 2′. Sealing means 27 forms a fluid seal, that is, a seal that is not permeable by gas or liquid, between the feed and the permeate. In some embodiments such as shown in FIG. 6b, the second connector 262 is connected to two screening devices 21, 21′ and each end of the second connector 262 is connected to the screening device 21 by inserting one end of the second connector 262 through the orifice 23 of the screening device 21.

Shown in FIG. 9b, there can be one or more individual membrane elements 2″ positioned in series between the two filtration units 10,10′. The filtration system 1 further comprises a second connector 262 to connect every two neighboring membrane elements 2, 2″, and the filtration element 2,2″ of the filtration unit 10,10′ is connected indirectly with the screening device 21,21′ by fitting a connector 261, 261′ to connect both the screening device 21, 21′ and the filtration element 2, 2′ separately. As shown in FIG. 9a, the external ring 25 may further comprise an external surface 253 with at least a supporting rib 251 which is a circular O-ring around the external ring 25 to seal between the external ring 25 and the inner surface of the vessel 3.

Shown in FIG. 8b, alternatively, two or more filtration units 10,10′,10″ are positioned in series, each filtration unit 10,10′,10″ comprises two or more screening devices 21,21′, and each end of the filtration element 10,10′,10″ is connected with at least one screening device 21,21′. The filtration system 1 further comprises a second connector 262 to connect every two neighboring membrane elements 10,10′,10″, and the filtration element 10,10′,10″ is connected directly with the screening device 21,21′ by attaching and fixing the screening device 21,21′ to the filtration element 10,10′,10″. As shown in FIG. 8a, the inner surface 252 of the external ring 25 of the screening device 21, 21′ is connected with the housing 11. The inner surface 252 is connected to the housing 11 by optional snap-in means, corresponding grooves and protrusions, screw threads, heat welding, press welding, glue, a combination of two or more of these methods, or another non-limited means. Preferably the inner surface 252 of the external ring 25 is sealed relatively to the housing 11 of the filtration element 2 to avoid the feed flowing to the first surface of the filtration membrane 9 between the potential gap between the inner surface of the external ring 25 and the housing 11.

Shown in FIGS. 4a and 4c, the second connector 262 is of hollow shape, with sealing means 27 at both ends of the second connector 262. The second connector 262 is suited to connect every two neighboring membrane elements 2 by inserting each end into the central pipe 8 of a filtration element 2 and sealing between the feed and the permeate.

The filtration membrane 9 is selected from the group of MF, UF, NF, distillation, degassing, ion exchange and RO membranes. The type of membrane is selected independently for each filtration unit. Stated alternatively, the filtration units may include the same type or different types of the filtration membranes. Preferably the filtration membrane 9 is selected from MF and UF. Normal cleaning processes for UF and MF include backwash, air scouring, CEB, and CIP, and other methods known to those of skill in the art. The most frequently applied cleaning process is backwash, which is typically conducted once every 20 to 60 minutes based on feed conditions. With the filtration unit 10 and filtration system 1 described herein, when cleaning such as backwash is applied to clean the MF and/or UF membranes, the same cleaning process is also applied to the screening device 21. Therefore, no separating cleaning steps or additional cleaning agents are needed for separately cleaning the screening devices 21 and the filtration element 2, which largely reduces the maintenance time and cost, and highly improves the operation efficiency. Furthermore, the filtration elements described herein enable one-control-philosophy for the filtration unit 10 with both screening device 21 and filtration element 2.

In a multi-element filtration system 1, the filtration membranes 9 of different filtration elements 2 may have the same or different materials, pore sizes, morphologies, dimensions, and shapes, etc. Different filtration elements 2 in the filtration system 1 may have the same or different configurations, membrane areas, etc. For example, as shown in FIG. 6, a downstream filtration element 2′ may have filtration membranes 9′ with larger or smaller pore sizes than that of the filtration membrane 9 in an upstream filtration element 2.

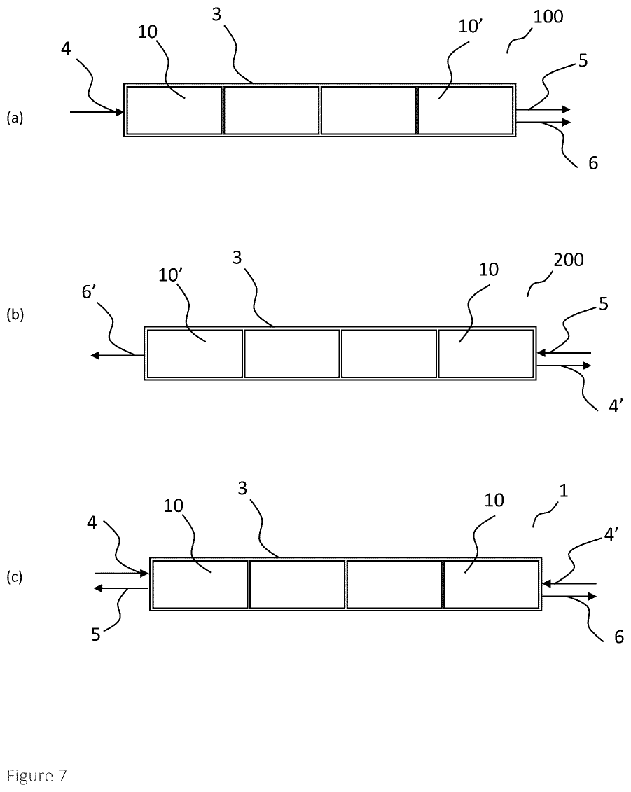

The feed flow direction of the filtration unit 10 and the filtration system 1 is reversable. As shown in FIG. 7a, the filtration system 100 comprises a vessel 3, two sides with multiple ports including a feed port 4, a permeate outlet 5, optionally a retentate outlet 6, a first filtration unit 10, and a second filtration unit 10′. As shown in FIG. 7b, when the feed flow reverses compared with the flow direction in FIG. 7a, the filtration system 100 turns into the filtration system 200. The filtration system 200 comprises a vessel 3, two sides with multiple ports including a feed port 4′ previously as a retentate outlet 6 of the filtration element 100, a retentate outlet 6′ previously as a feed port 4 of the filtration element 100, a permeate outlet 5, a first set of filtration unit 10, and a second set of filtration unit 10′. As shown in FIG. 7c, the filtration system 1 comprises a vessel 3, two sides with multiple ports including feed ports 4,4′, a permeate outlet 5, a retentate outlet 6, two sets of filtration unit 10, and the feed is introduced from the feed ports 4,4′ from both sides of the filtration system 1. There may also be permeate ports 5 from both sides of the filtration system 1, otherwise one end of the central pipe 8 may be inserted by a plug 30 to seal between the permeate and the feed or the retentate, as shown in FIG. 5a and FIG. 5c.

Numbers for reference

| Number | FIG. | Item |
|---|---|---|
| 1 | 1 | Filtration system |
| 100 | 6 | |
| 200 | 6 | |
| 2 | 1 | Filtration element |
| 2′ | 7, 8 | Filtration element |
| 2″ | 8 | Individual filtration element |
| 3 | 1 | Vessel |
| 4 | 1 | Feed port (in original feed flow direction) |
| 4′ | 6 | Feed port (in reversed feed flow direction) |
| 5 | 1 | permeate outlet (in original feed flow direction) |
| 5′ | 6 | permeate outlet (in reversed feed flow direction) |
| 6 | 1 | Retentate outlet |
| 7 | 1 | Air inlet port |
| 10, 10′, 10″ | 2, 7, 8 | Filtration unit |
| 11 | 2 | Housing |
| 21 | 2 | Screening device |
| 22 | 2 | Screening body |
| 23 | 2 | Orifice |
| 24 | 2 | Supporting beam |
| 240 | 2 | External ring |
| 25 | 2 | Spacer ring |
| 251 | 2 | Rib |
| 261, 261′ | 2, 7, 8 | Connector |
| 262 | 8 | Second connector |
| 27 | 4 | Sealing means |
| 28 | 4 | Hollow chamber |
| 29 | 4 | Protruded base |
| 9, 9′ | 5 | Filtration membrane |
| 8, 8′ | 5 | Central pipe |

While certain of the preferred embodiments of the present invention have been described and specifically exemplified above, it is not intended that the invention be limited to such embodiments. Rather, it is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A filtration unit comprising:
a filtration element comprising at least one filtration membrane with a first surface for contacting feed and a second surface for contacting permeate;
wherein the filtration element comprises at least one end, and said end(s) comprise one or more openings to introduce a feed to the first surface of the filtration membrane; and wherein the filtration element further comprises a central pipe surrounded by the filtration membrane(s) to collect permeate and a backwashable screening device connected to the end of the filtration element comprising the one or more openings;
wherein the screening device comprises an orifice substantially positioned in the center of the screening device, an external ring in the outer periphery of the screening device, and a screening mesh body therebetween, the screening mesh body having a screening size of between 50 microns and 400 microns.

2. The filtration unit of claim 1, wherein the external ring comprises an external surface comprising at least a supporting ridge; or
wherein the filtration membrane is surrounded by a housing, and the external ring comprises an inner surface that is connected to the housing.

3. (canceled)

4. The filtration unit of claim 1, wherein the filtration element comprises two ends, wherein each of the two ends comprises the one or more openings; and further wherein the filtration unit comprises two or more screening devices; and wherein each end of the filtration element is connected to at least one screening device.

5. The filtration unit of claim 4, wherein the feed has a flow direction through the filtration unit, and wherein the flow direction is reversable.

6. The filtration unit of claim 1, wherein the filtration unit further comprises a first connector to direct the permeate collected in the central pipe, wherein the first connector is equipped with a sealing means; and wherein the first connector is inserted through the orifice of the screen device and into the central pipe of the filtration element to connect the screening device and the filtration element;
wherein the sealing means seals between the first connector and the central pipe, forming a fluid seal between the feed and the permeate.

7. The filtration unit of claim 6, wherein the first connector further comprises a second sealing means to seal between the first connector and the orifice.

8. The filtration unit of claim 7, wherein the inner surface of the external ring is sealed relatively to the housing of the filtration element.

9. The filtration unit of claim 1 wherein the screening device comprises at least two layers of screening mesh bodies between the orifice and the external ring; and optionally wherein at least two layers of the screening mesh bodies have different screening sizes.

10. (canceled)

11. (canceled)

12. The filtration unit of claim 1, wherein the filtration membrane is selected from the group consisting of microfiltration and ultrafiltration membranes.

13. A filtration system comprising a vessel, two sides equipped with multiple ports including a first feed port, a permeate outlet, and optionally a retentate outlet, and at least one filtration unit placed within the vessel, wherein the filtration unit comprises:
a filtration element comprising at least one filtration membrane with a first surface for contacting feed and a second surface for contacting permeate;
wherein at least one end of the filtration element comprises one or more openings to introduce a feed to the first surface of the filtration membrane;
and wherein the filtration element further comprises a central pipe surrounded by the filtration membrane to collect permeate; and
a backwashable screening device connected to the at least one end of the filtration element, said screening device comprising an outer periphery;
wherein the screening device comprises an orifice substantially positioned in the center of the screening device, an external ring in the outer periphery of the screening device, and a screening mesh body disposed between the orifice and the outer periphery; and wherein the screening mesh body has a screening size of between 50 microns and 400 microns.

14. The filtration system of claim 13, wherein the filtration system comprises at least two filtration units, and wherein one screening device of one filtration unit is positioned next to each side of the filtration system.

15. The filtration system of claim 13, wherein the filtration system further comprises a second feed port at the opposite side of the filtration system from the first feed port, and the feed flows to one or both feed ports.

16. The filtration system of claim 13, wherein the feed has a flow direction through the filtration unit(s), and wherein the flow direction is reversable.

17. The filtration system of claim 13, wherein the vessel comprises an inner surface, and wherein the external ring comprises an external surface, said external surface comprising at least a supporting ridge to face against the inner surface of the vessel.

18. The filtration system of claim 13, wherein the filtration membrane is surrounded by a housing, and the external ring comprises an inner surface connected to the housing; wherein the filtration element comprises two ends, and the two ends comprise openings via which the feed can be introduced to the first surface of the filtration membrane;
wherein the filtration unit comprises two or more screening devices; and
wherein each end of the filtration element is connected with at least one screening device.

19. The filtration system of claim 13, wherein at least one filtration unit further comprises a first connector and a second connector to direct the permeate collected in the central pipe of the filtration element, wherein the first connector and the second connector are equipped with a sealing means; wherein the first connector connects with one filtration unit and the second connector connects with two filtration units; wherein the first connector and the second connector are inserted through the orifice(s) of the screening device(s) of the filtration unit(s) to which they are connected and are inserted into the central pipe(s) of the filtration element(s); wherein the sealing means seals between the first connector and the central pipe to which it is connected, and between the second connector and the central pipes to which it is connected, forming a fluid seal between the feed and the permeate.

20. The filtration system of claim 19, wherein the first connector further comprises another sealing means to seal between the connector and the orifice.

21. The filtration system of claim 18, wherein the inner surface of the external ring is sealed relatively to the housing of the filtration element.

22. The filtration system of claim 13, wherein the screening device comprises at least two layers of screening mesh bodies between the orifice and the external ring; and optionally wherein at least two layers of the screening mesh bodies have different screening sizes.

23. (canceled)

24. (canceled)

25. The filtration system of claim 13, wherein the filtration membrane is selected from the group consisting of microfiltration and ultrafiltration membranes.
